(19) United States
(12) Patent Application Publication
(10) Pub. No.: US 2011/0231889 A1
(43) Pub. Date: Sep. 22, 2011

(54) SECURITY POLICY AS QUERY PREDICATE

(75) Inventors: VIJAY DHEAP, Durham, NC (US); Abhinaya Ravinder Nagpal, Pune (IN); Sandeep R. Patil, Pune (IN); Yan Stein, (US)

(73) Assignee: International Business Machines Corporation, Armonk, NY (US)

(21) Appl. No.: 12/728,780

(22) Filed: Mar. 22, 2010

(51) Int. Cl. G06F 21/00; G06F 17/30

(52) U.S. Cl. 726/1; 707/759; 707/E17.132

(57) ABSTRACT

A method, system, and computer usable program product for applying a security policy as a query predicate. A query is received. The query is a request for data directed to a data repository executing in a data processing system. The security policy is identified, the security policy being a security policy applicable to the query. A predicate that corresponds to the security policy is determined. The query is modified to include the predicate. The modified query is sent to the data repository.

### BACKGROUND OF THE INVENTION

1. Field of the Invention

The present invention relates generally to an improved data processing system, and in particular, to a computer implemented method for improving the reading and writing of data. More particularly, the present invention relates to a computer implemented method, system, and computer usable program code for applying a security policy as a query predicate.

2. Description of the Related Art

Data security is a significant concern in data processing environment. One aspect of data security is controlling access to data under a variety of circumstances. For example, according to one data security configuration, certain data may be accessible only to users and applications with specific identifiers. According to another example security configuration, certain data may be available to a certain group of users or applications during a defined period.

According to another example security configuration, only a portion of a record may be visible to one user whereas a different portion of the same record may be visible to another user. Another example security configuration may allow one user to only view a record while allowing another user to view as well as modify the record.

Some data processing environments employ security policies that enable data security enforcement over distribution and use of data in those environments. Generally, a security policy includes a rule that should be enforced when certain conditions exist.

Security policies are generally implemented in a system that does not store the data directly. For example, in one common configuration, the security policies are created, managed, and administered from a security policy manager application. An application calls the security policy manager application to receive a security policy applicable to the data that is being requested. The application applies the policy to the requested data.

### SUMMARY OF THE INVENTION

The illustrative embodiments provide a method, system, and computer usable program product for applying a security policy as a query predicate. An embodiment receives a query. The query is a request for data directed to a data repository executing in a data processing system. The embodiment identifies the security policy, the security policy being a security policy applicable to the query. The embodiment determines a predicate that corresponds to the security policy. The embodiment modifies the query to include the predicate. The embodiment sends the modified query to the data repository.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of a data processing system configuration in which an illustrative embodiment may be implemented;

FIG. 4 depicts a block diagram of a system for applying security policies as query predicates in accordance with an illustrative embodiment;

FIG. 5 depicts a bock diagram of a modified query in accordance with an illustrative embodiment;

FIG. 6 depicts a block diagram of one example configuration of a system for applying security policies as query predicates in accordance with an illustrative embodiment;

FIG. 7 depicts a block diagram of another example configuration of a system for applying security policies as query predicates in accordance with an illustrative embodiment;

FIG. 8 depicts a block diagram of another example configuration of a system for applying security policies as query predicates in accordance with an illustrative embodiment;

FIG. 9 depicts a block diagram of an example schema of a database for using security policy predicates to in accordance with an illustrative embodiment;

FIG. 10 depicts a block diagram of an example modification of a schema of a database for using security policy predicates to in accordance with an illustrative embodiment;

FIG. 11 depicts a block diagram of another example modification of a schema of a database for using security policy predicates to in accordance with an illustrative embodiment;

FIG. 12 depicts a flowchart of a process of applying a security policy as a query predicate in accordance with an illustrative embodiment; and

FIG. 13 depicts a flowchart of a process of modifying a database schema to be usable with security policy predicates in accordance with an illustrative embodiment.

### DETAILED DESCRIPTION OF THE PREFERRED EMBODIMENT

Many applications interact with databases for accessing, using, and manipulating data contained therein. Such an application is a client of a database, or database server, and is often referred to as a database client application.

Typically, a database client application presents a query to the database and the database responds with a data set. A query is a formatted request for data, the format of the query being according to a defined syntax and specification, and in a language understood by the database. A data set is data resulting from the query.

In a data processing environment where such query and responses occur between a database client application and a database, the data being transferred may be subject to certain security measures. For example, a user may query for information about a group of employees of a company. A database, such as an employee database, may return a data set that includes information about domestic and foreign employees of the company. The data returned by the database may be governed by a security policy that a group to which the particular user associated with the query belongs be given access to only domestic data and no foreign data. Accordingly, the data set returned by the database in response to a query has to be filtered, altered, or otherwise modified to comply with the security policy before the data set is sent to the user.

The invention recognizes that presently, security policies are not applied to database transactions in a computationally efficient manner. The invention further recognizes that the manner of application of security policies to database transactions leaves data susceptible to security breach.

For example, the invention recognizes that when query and response occur between a database client application and a database, the database generates the data set that satisfies the query. The data set is then subjected to restrictions, reduction, or other manipulations to comply with the security policy. In such an operation, the database often produces a larger data set than can be sent in response to the query in compliance with the security policy. The transmission of the larger data set exposes the restricted data during transmission from the database to the application that applies the security policy. Producing the larger data set causes larger than required data volume to be retrieved from the database, transmitted for security policy administration, and then to be computationally reduced. Thus, the invention recognizes that present operations, such as in the above example, introduce inefficiencies and insecurities in database interactions.

The illustrative embodiments used to describe the invention generally address and solve the above-described problems and other problems related to database interactions. The illustrative embodiments provide a method, computer usable program product, and data processing system for applying a security policy as a query predicate.

An embodiment of the invention may enable the data processing system to modify the query such that the data set resulting from the modified query is already security policy compliant. Thus, an embodiment may allow a database to produce only that smaller amount of data that can be returned in response to the query as compared to the larger data set presently produced. The data in the data set based on the modified query is already security policy compliant; thus, no non-compliant data is exposed during transmission.

An embodiment may modify the query such that the security policy that may be applicable to the resulting data is included in the modified query as a predicate. A query includes attributes and conditions. An attribute in a query may be an identifier usable to locate data in a database.

For example, an attribute may be a column name, a table name, a row identifier, a value of data stored in a particular location or a combination thereof. A condition is a logical computation capable of producing a Boolean result or for identifying data in a database. For example, a condition may be “where firstName=‘John’”, and may result in data records that include a first name “John.” As another example, a condition may be “exists” for detecting whether a data record meeting a particular criterion exists in the database, and may result in a True or False answer.

A query may also include operations. An operation manipulates data during or after the processing of the query. For example, an operation may be “order by” which may order the partial result of the query processing according to some order. As another example, string operations may be included in a query to truncate, search, or perform other string operations on the partial data.

A predicate can be any combination of one or more attributes, one or more conditions, and one or more operations. A query may include any number of attributes and conditions organized in any number of predicates.

The illustrative embodiments are described with respect to data, data structures, indicators, and identifiers only as examples. Such descriptions are not intended to be limiting on the invention. For example, an illustrative embodiment described with respect to a database may be implemented using a file-system in a similar manner within the scope of the invention.

Furthermore, the illustrative embodiments may be implemented with respect to any type of data processing system. For example, an illustrative embodiment described with respect to a relational database may be implemented in an object oriented database, an XML database, or a hybrid database, within the scope of the invention.

The illustrative embodiments are further described with respect to certain parameters, attributes, and configurations only as examples. Such descriptions are not intended to be limiting on the invention. An embodiment of the invention may be implemented with respect to any type of data processing system, such as, for example, any type of client system, server system, middleware system, file system, or a combination thereof.

An application implementing an embodiment may take the form of data objects, code objects, encapsulated instructions, application fragments, services, and other types of software implementations available in a data processing environment. For example, Java® data object (JDO), an Enterprise Java Bean (EJB®), a servlet, or an applet may be manifestations of an application with respect to which, within which, or using which, the invention may be implemented. (Java, EJB, and other Java related terminologies are registered trademarks of Sun Microsystems, Inc. in the United States and other countries.)

An application implementing an embodiment of the invention can be coded using any programming language, such as Java, C, C++, Perl, Python, Ruby, or PL/1. Differences in implementations of databases interfaces to such applications in different languages are contemplated within the scope of the invention. For example, one application implementing an embodiment may interface with a database using a servlet or EJB, whereas another application implementing the embodiment may interface with a database using a CGI or JDO within the scope of the invention.

An illustrative embodiment may be implemented in hardware, software, or a combination thereof. The examples in this disclosure are used only for the clarity of the description and are not limiting on the illustrative embodiments. Additional or different information, data, operations, actions, tasks, activities, and manipulations will be conceivable from this disclosure for similar purpose and the same are contemplated within the scope of the illustrative embodiments.

The illustrative embodiments are described using specific code, data structures, file systems, designs, architectures, layouts, schematics, and tools only as examples and are not limiting on the illustrative embodiments. Furthermore, the illustrative embodiments are described in some instances using particular data processing environments only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

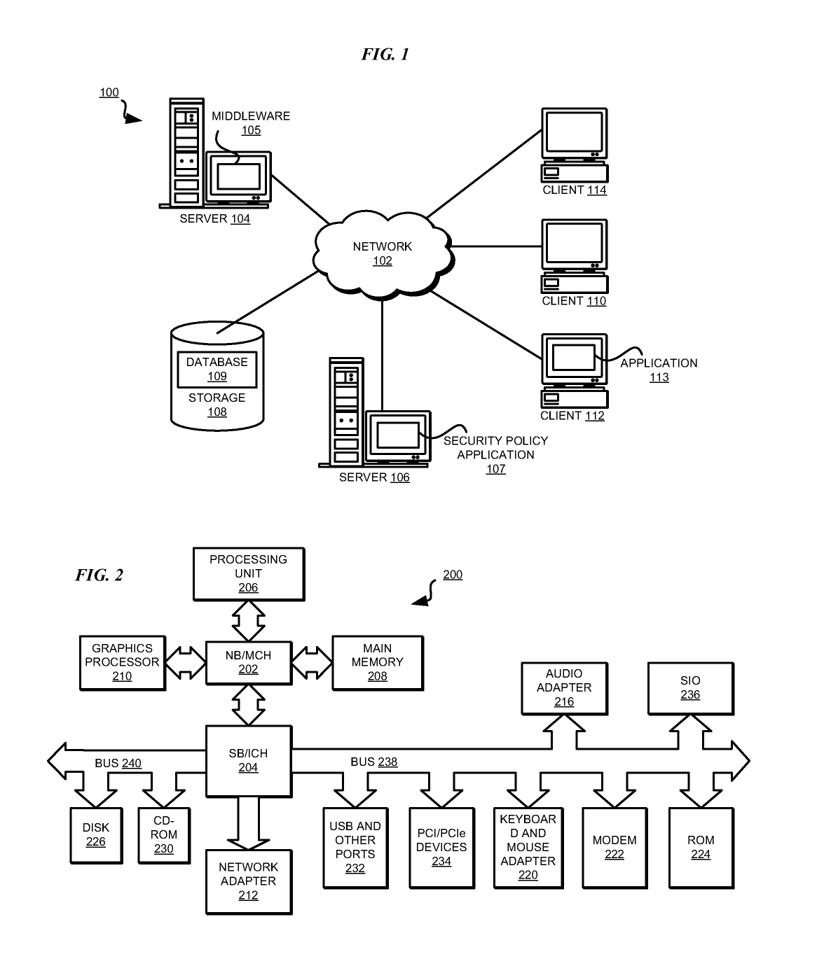

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Server 104 may include middleware 105. Server 106 may include security policy application 107. Storage 108 may include database 109. Client 112 may include application 113. Middleware 105 may be any application facilitating data communication between applications, including databases, in data processing environment 100. Database 109 may be any type of database or data repository. Security policy application 107 may be an application configured to create, manipulate, or administer security policies in data processing environment 100. Application 113 may be any application interacting with database 109, for example, via middleware 105.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States and other countries), Linux® (Linux is a trademark of Linus Torvalds in the United States and other countries), AIX®, z/OS® (AIX and z/OS are trademarks of IBM Corporation in the United States and other countries), or Solaris® (Solaris is a trademark of Sun Microsystems, Inc., in the United States and other countries). An object-oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. For example, a storage device may be associated with a server, such as server 104 or 106 in FIG. 1, or a client, such as client 112 or 114 in FIG. 1. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors.

The depicted examples in FIGS. 1-2 and above-described examples are not meant to imply architectural limitations. For example, data processing system 200 also may be a tablet computer, laptop computer, or telephone device in addition to taking the form of a PDA.

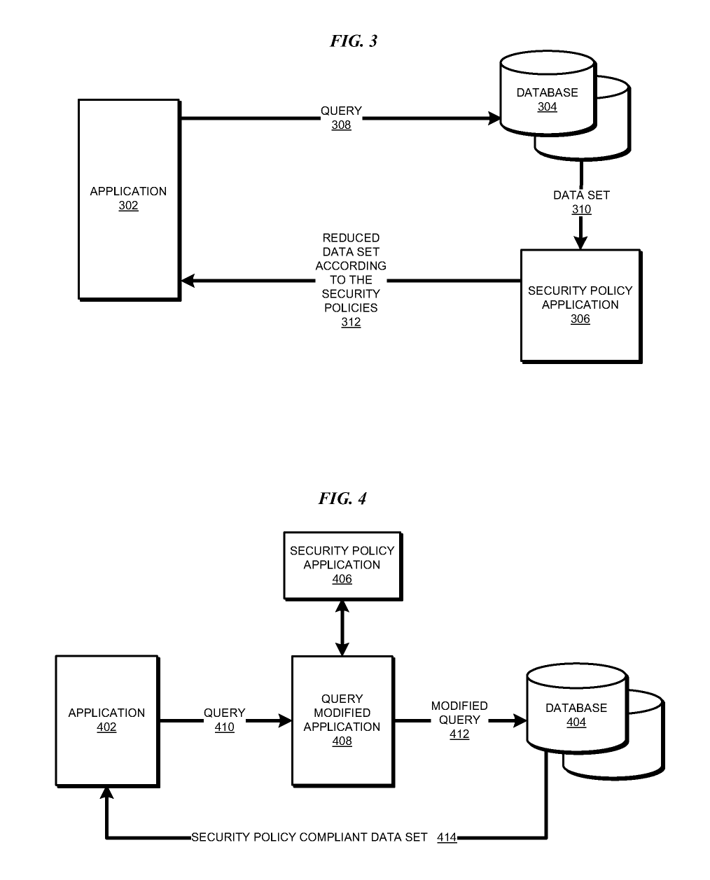

With reference to FIG. 3, this figure depicts a block diagram of a data processing system configuration in which an illustrative embodiment may be implemented. Application 302 may be similar to application 113 in FIG. 1. Database 304 may be implemented using database 109 in FIG. 1. Security policy application 306 may be similar to security policy application 107 in FIG. 1 and may manipulate the data set in compliance with a security policy.

Application 302 sends query 308 to database 304. Database 304 generates data set 310 that satisfies query 308. Data set 310 is sent to or intercepted by security policy application 306. Security policy application 306 manipulates data set 310 such that no data in data set 310 that is contrary to a security policy applicable to query 308 is sent to application 302. Security policy application 306 creates reduced data set 312 according to the applicable security policies. Security policy application 306 sends reduced data set 312 to application 302.

The configuration depicted in this figure is a simplified example configuration where an embodiment of the invention can be beneficially implemented. Other systems, applications, or networks (not shown) may be present in a configuration together with the shown components.

As the invention recognizes, data set 310 may include data that may be removed by security policy application 306. However, prior to removal, such data has to be computed or retrieved at database 304 and transmitted to security policy application 306, perhaps over a data network. Security policy application 306 has to expend computing resources to reduce data set 310 to reduced data set 312.

Thus, as the invention recognizes, the configuration of FIG. 3 is computationally intensive and may expose data set 310 to a security breach. Furthermore, such a configuration may also be expensive in computing time and other computing resources. Accordingly, the configuration of FIG. 3, and other comparable configurations may benefit from an illustrative embodiment.

With reference to FIG. 4, this figure depicts a block diagram of a system for applying security policies as query predicates in accordance with an illustrative embodiment. Application 402 may be similar to application 302 in FIG. 3. Database 404 may be similar to database 304 in FIG. 3.

In one embodiment, security policy application 406 may be similar to security policy application 306 in FIG. 3. In another embodiment, security policy application 406 may be any source of information that is usable as a security policy.

Query modification application 408 may be an application or a component of an application. Query modification application 408 may receive query 410 directed to database 404 from application 402. Query modification application 408 may also receive security policy information, such as from security policy application 406.

Query modification application 408 correlates the contents of query 410 with a set of security policies and select one or more security policies that may be applicable to query 410. A set of security policies is one or more security policies. For example, if query pertains to employee data, a security policy pertaining to distribution of employee data may be applicable to query 410. As another example, if query 410 has an identifier identifying the originator of query 410, a security policy concerning information requests by various users and user groups may be applicable to query 410.

The correlation of security policies to queries is likely to be implementation specific and may vary between implementations. The correlation function of query modification application 408 can be implemented in any manner suitable to a particular data processing environment within the scope of the invention.

Query modification application 408 may convert a rule of a selected security policy into a predicate that can be included in query 410. For example, a rule of a selected security policy may be to restrict a data set to only domestic data under certain circumstances. Accordingly, query modification application 408 may include “where country=US” predicate in query 410.

Query modification application 408 may correlate any number of security policies with query 410. A security policy may include any number of rules. Query modification application 408 may transform a rule of a security policy into any number of predicates.

Query modification application 408 may combine a set of predicates created in this manner with query 410 to create modified query 412. A set of predicates is one or more predicates. Modified query 412 is a valid query that generates a security policy compliant data set 414. Security policy complaint data set 414 may be returned to application 402 in any suitable manner.

Modified query 412 is a valid query that performs the operation desired from query 410, but within the security policy constraints. In combining a predicate resulting from a security policy with query 410, query modification application 408 may manipulate existing predicates in query 410 within the scope of the invention.

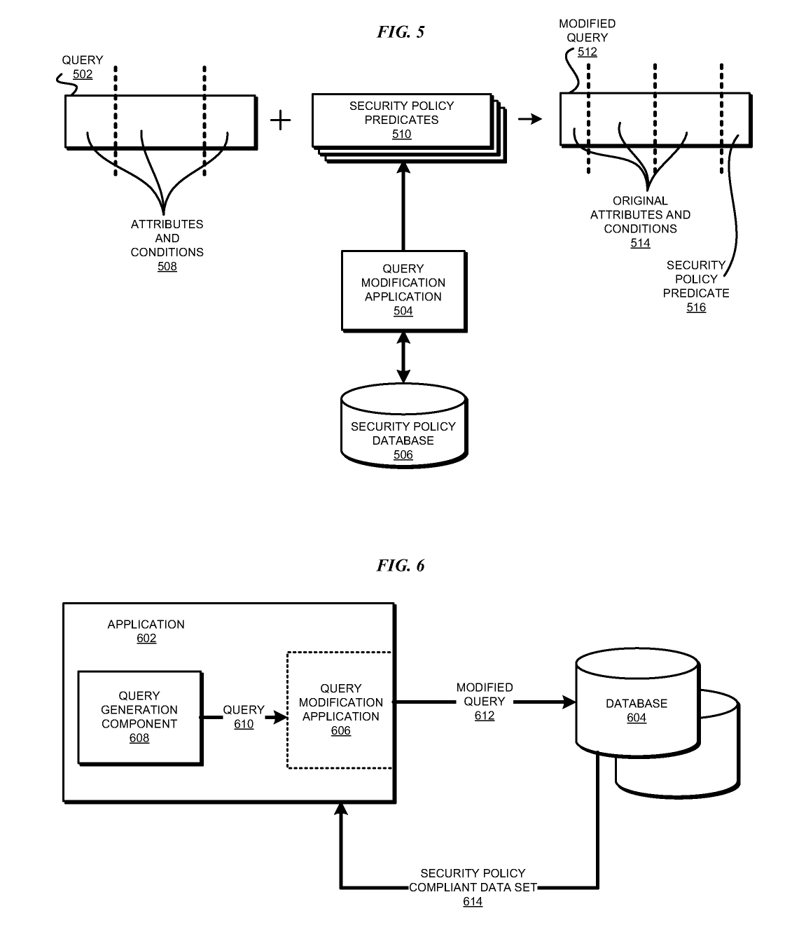

With reference to FIG. 5, this figure depicts a bock diagram of a modified query in accordance with an illustrative embodiment. Query 502 may be similar to query 410 in FIG. 4.

Query modification application 504 may be similar to query modification application 408 in FIG. 4. Query modification application 504 may communicate with security policy database 506. Security policy database 506 may be a database or any type of repository, may be similar to security policy application 406 in FIG. 4, or may be any other source of security policy information.

Query 502 includes attributes and conditions 508. Attributes and conditions 508 may be organized into existing predicates in query 502.

Query modification application 504 may create a set of security policy predicates 510 corresponding to one or more security policy information received from security policy database 506. Query modification application 504 combines the entire set of security policy predicates 510, or a subset thereof, with existing predicates of query 502. The combination creates modified query 512.

Modified query 512 includes original attributes and conditions 514. Original attributes and conditions 514 may be identical to attributes and conditions 508, or may be a logical recombination or rearrangement thereof. Modified query 512 further includes security policy predicate 516. Security policy predicate 516 may be a subset of security policy predicates 510.

A security policy predicate in security policy predicate 516 may further be identical to a security policy predicates in security policy predicates 510 or may be a modified form thereof as may be suitable for constructing a valid modified query 512. Furthermore, original attributes and conditions 514 and security policy predicate 516 may appear anywhere in modified query 512 and in any form without limitation.

Following are some examples of database configuration, example queries, example security policies, and example modified queries in accordance with an illustrative embodiment. These examples are only provided for clarity of the description of the operation of an embodiment and are not intended to be limiting on the invention. Other database configurations, queries, and security policies can be used in a similar manner to form modified queries within the scope of the invention.

As an example, a database may have a table client_r, described as:

create table table client_r (
id int primary key not null,
name varchar(50),
country varchar(30),
street varchar(60),
city varchar(20),
prov_state varchar(20),
pcode_zip varchar(10),
work_phone varchar(15),
home_phone varchar(15)
);

An example security policy may be defined as—users with label “Employee” can only access records of clients in ‘Canada’. Assume that a database application associated with user A has a label “Employee”. The application may send an example query as follows:

select street, city, prov_state, pcode_zip
from client_r
where pcode_zip = “95116”

As an example, a query modification application according to an embodiment may check a security policy repository as follows:

(userID, securityLabelID) joins

(securityLabelID, securityLabelName, format, action)

==>
(userID, securityLabelName, format, action)
userA, Employee, relational, country = “Canada”
userB, usEmployee, relational, country = “USA”
userA, Employee, xml,
$CONTACTINFO/customerinfo/customer/addr[@country

= “Canada”]

userC, ...

The query modification application may find a matched entry in this checking, and may apply an action associated with the security policy to the original query. The query modification application may generate a new or modified query including a security-based predicate as follows:

select street, city, prov_state, pcode_zip
from client_r
where pcode_zip = “95116”
and country = “Canada”

In the above example, the security policy repository is depicted as using relational tables to store the data only for clarity and is not intended to be a limitation on the invention. An embodiment may use a security policy repository that uses XML-based file or any other type of file structure to store policy information within the scope of the invention.

Furthermore, an embodiment may also handle data requests to data repositories other than relational databases in a similar manner. For example, an embodiment may apply similar logic to an eXtensible Markup Language (XML) based data repository and an XML request. Assume that an XML repository defines a table “client x” as follows:

create table client_x(
id int primary key not null,
contactinfo xml
);

The application associated with user A, as in the previous example, may send the following query to the XML repository:

xquery
for $y in db2-

fn:xmlcolumn(‘CLIENTS.CONTACTINFO’)/customerinfo/customer/a
ddr

where $y/pcode_zip=“95116”
return $y

A query modification application according to an embodiment may use a security policy repository to locate a security policy that provides—users with label “Employee” can only access records of clients in ‘Canada’. The query modification application may generate a predicate corresponding to this policy as follows:

$CONTACTINFO/customerinfo/customer/addr[@country=“Canada”]

The query modification application includes this predicate with the query sent from user A's application. The query modification application may then pass the modified query to the repository.

The repository may use the modified query in conjunction with other actions. For example the repository may evaluate certain access rights rules, such as permission to select, update, delete, and insert records as applicable to the modified query. As another example, the repository may explore possible optimized access paths or further optimize the modified query. The repository returns a data set in response to the modified query. The data set includes filtered data that is security policy compliant for returning to user A's application.

When no security policy is applicable to an original query, the query modification application may pass the original query without modification to the target database. The database processing the query remains unaware whether the query has been modified, whether a security policy has been applied prior to the query reaching the database.

With reference to FIG. 6, this figure depicts a block diagram of one example configuration of a system for applying security policies as query predicates in accordance with an illustrative embodiment. Application 602 may be similar to application 402 in FIG. 4. Database 604 may be similar to database 404 in FIG. 4.

Query modification application 606 may be analogous to query modification application 504 in FIG. 5. In one embodiment, query modification application 606 may be a component of application 602. In another embodiment, query modification application 606 may be a service utilized by application 602. In another embodiment, query modification application 606 may be an application that is usable in conjunction with application 602.

Query generation component 608 may be a component of application 602 that creates queries for database 604. Query 610 may be an example of such a query. Query 610 may be similar to query 502 in FIG. 5.

Query modification application 606 receives query 610. Query modification application 606 modifies query 610, for example in the manner described with respect to FIG. 5. Query modification application 606 produces modified query 612. Application 602 sends modified query 612 to database 604.

Query modification application 606 may utilize one or more security policy information sources for creating modified query 612. Because modified query 612 includes security policy predicates, database 604 responds with data set 614 that is security policy compliant.

Modified query 612 and data set 614 may each be communicated over a data network. Furthermore, one or more systems or applications may intervene in such communication over a data network within the scope of the invention. Furthermore, modified query 612, data set 614, or both, may be encrypted or otherwise converted, such as for transmission over a public data network, within the scope of the invention.

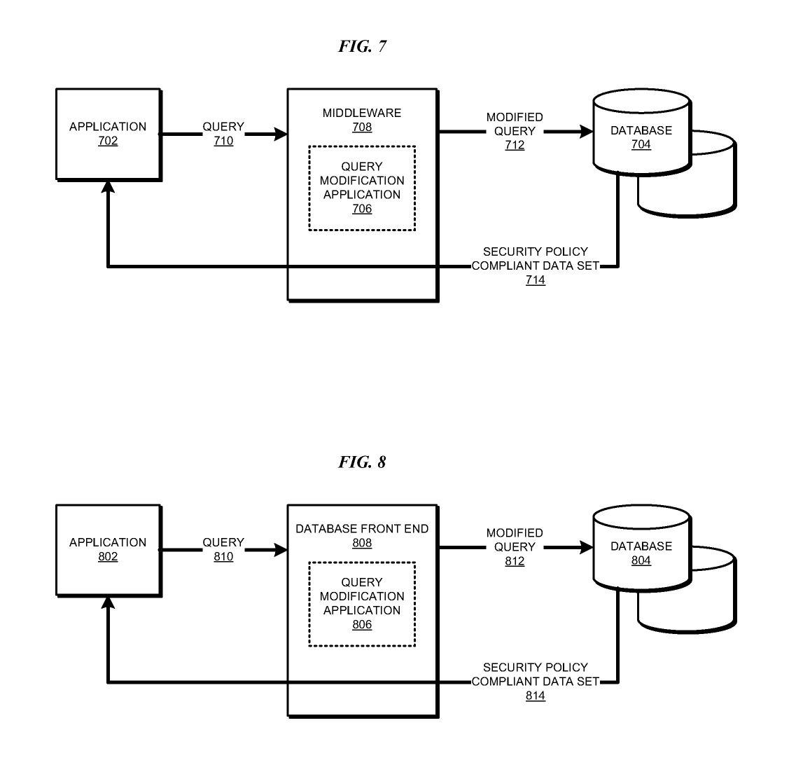

With reference to FIG. 7, this figure depicts a block diagram of another example configuration of a system for applying security policies as query predicates in accordance with an illustrative embodiment. Application 702 may be similar to application 402 in FIG. 4. Database 704 may be similar to database 404 in FIG. 4.

Query modification application 706 may be analogous to query modification application 504 in FIG. 5. In one embodiment, query modification application 706 may be a component of middleware 708. Middleware 708 may be analogous to middleware 105 in FIG. 1. In another embodiment, query modification application 706 may be a service utilized by middleware 708. In another embodiment, query modification application 706 may be an application that is usable in conjunction with middleware 708.

Application 702 may create queries for database 704. Query 710 may be an example of such a query. Query 710 may be similar to query 502 in FIG. 5.

Middleware 708 may receive query 710. Middleware 708 may pass query 710 to query modification application 706. Query modification application 706 modifies query 710, for example in the manner described with respect to FIG. 5. Query modification application 706 produces modified query 712. Middleware 708 sends modified query 712 to database 704.

Query modification application 706 may utilize one or more security policy information sources for creating modified query 712. Because modified query 712 includes security policy predicates, database 704 responds with data set 714 that is security policy compliant. Data set 714 is shown as being communicated through middleware 708 only as an example configuration. In an embodiment, data set 714 may not be communicated via middleware 708.

Query 710, modified query 712, data set 714, or a combination thereof, may be communicated over a data network. Furthermore, one or more systems or applications may intervene in such communication over a data network within the scope of the invention. Furthermore, query 710, modified query 712, data set 714, or some combination thereof, may be encrypted or otherwise converted, such as for transmission over a public data network, within the scope of the invention.

With reference to FIG. 8, this figure depicts a block diagram of another example configuration of a system for applying security policies as query predicates in accordance with an illustrative embodiment. Application 802 may be similar to application 402 in FIG. 4. Database 804 may be similar to database 404 in FIG. 4.

Query modification application 806 may be analogous to query modification application 504 in FIG. 5. In one embodiment, query modification application 806 may be a component of database front end 808. In another embodiment, query modification application 806 may be a service utilized by database front end 808. In another embodiment, query modification application 806 may be an application that is usable in conjunction with database front end 808. Database front end 808 may be an application usable with database 804. For example, database front end 808 may be a query pre-processor component of database 804. As another example, database front end 808 may be a database management application.

Application 802 may create queries for database 804. Query 810 may be an example of such a query. Query 810 may be similar to query 502 in FIG. 5.

Database front end 808 may receive query 810. Database front end 808 may pass query 810 to query modification application 806. Query modification application 806 modifies query 810, for example in the manner described with respect to FIG. 5. Query modification application 806 produces modified query 812. Database front end 808 sends modified query 812 to database 804.

Query modification application 806 may utilize one or more security policy information sources for creating modified query 812. Because modified query 812 includes security policy predicates, database 804 responds with data set 814 that is security policy compliant. Data set 814 is shown as being communicated through database front end 808 only as an example configuration. In an embodiment, data set 814 may not be communicated via database front end 808.

Query 810, modified query 812, data set 814, or a combination thereof, may be communicated over a data network. Furthermore, one or more systems or applications may intervene in such communication over a data network within the scope of the invention. Furthermore, query 810, modified query 812, data set 814, or some combination thereof, may be encrypted or otherwise converted, such as for transmission over a public data network, within the scope of the invention.

With reference to FIG. 9, this figure depicts a block diagram of an example schema of a database for using security policy predicates to in accordance with an illustrative embodiment. Schema 900 may be a schema of a database, such as database 404 in FIG. 4, 604 in FIG. 6, 704 in FIG. 7, or 804 in FIG. 8.

“Table_{—}1” and “Table_{—}2” may be example tables existing in schema 900. Table_{—}1 may include columns A, B, and C. Table_{—}2 may include columns D and E.

In one embodiment, portion 902 of existing schema 900 may be mapped to a security policy. For example, data in column C of Table_{—}1 may be suitable for using the security policy predicate embedded in the modified query. As an example, column C may be the column “action” from the example tables provided after the description of FIG. 5.

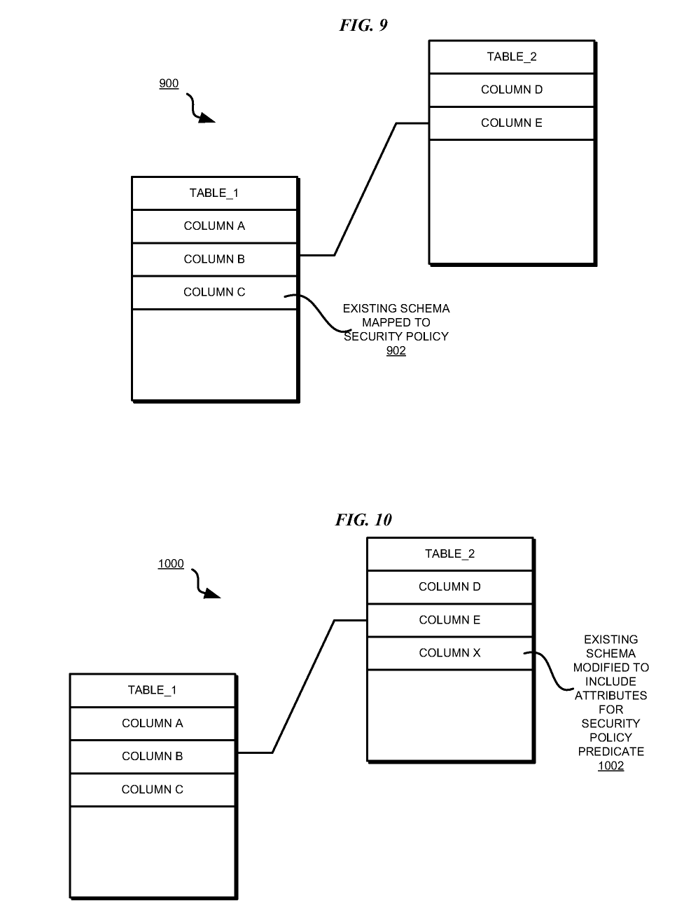

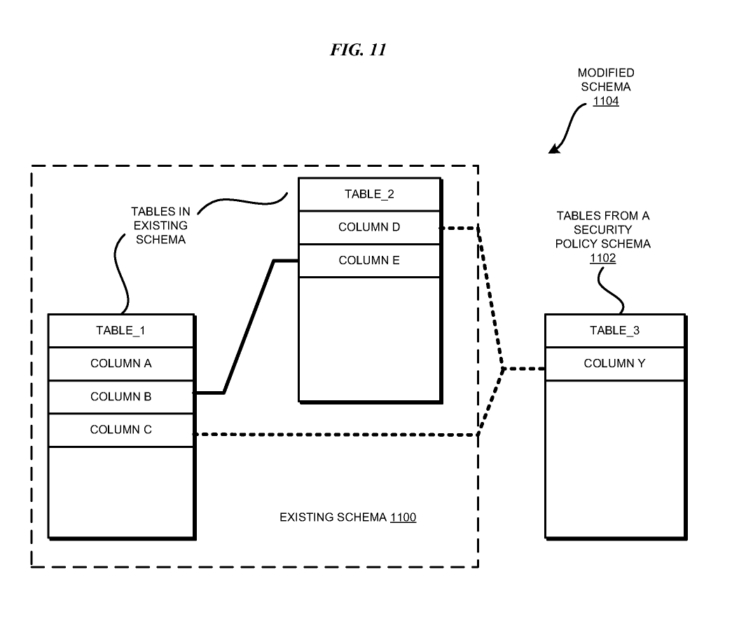

With reference to FIG. 10, this figure depicts a block diagram of an example modification of a schema of a database for using security policy predicates to in accordance with an illustrative embodiment. Schema 1000 may be a schema of a database, such as database 404 in FIG. 4, 604 in FIG. 6, 704 in FIG. 7, or 804 in FIG. 8.

“Table_{—}1” and “Table_{—}2” may be example tables existing in schema 1000. Table_{—}1 may include columns A, B, and C. Table_{—}2 may include columns D and E.

In one embodiment, no portion of existing schema 1000 may be sufficient for using a security policy predicate. To modify schema 1000 such that schema 1000 contains adequate data for using a security policy predicate, column X may be added to Table_{—}2 and populated with suitable data. As an example, column X may be the column “action” from the example tables provided after the description of FIG. 5.

With reference to FIG. 11, this figure depicts a block diagram of another example modification of a schema of a database for using security policy predicates to in accordance with an illustrative embodiment. Schema 1100 may be a schema of a database, such as database 404 in FIG. 4, 604 in FIG. 6, 704 in FIG. 7, or 804 in FIG. 8.

“Table_{—}1” and “Table_{—}2” may be example tables existing in schema 1100. Table_{—}1 may include columns A, B, and C. Table_{—}2 may include columns D and E.

In one embodiment, no portion of existing schema 1100 may be sufficient for using a security policy predicate. Furthermore, existing schema 1100 may not be modifiable in the manner of schema 1000 in FIG. 10.

To modify schema 1100 such that schema 1100 contains adequate data for using a security policy predicate, all or part of security policy schema 1102 may be combined with schema 1100. For example, Table_{—}3 having column Y may be combined with schema 1100 to result in modified schema 1104. As an example, Table_{—}3 may include “securityLabelID”, “securityLabelName”, “format”, and “action” columns from the example tables joined after the description of FIG. 5. Column Y may be the column “action” in such an example table.

Different security policies may produce different security policy predicates. Different security policy predicates, in turn, may have to use different data from schema 1000. Accordingly, schema 1000 may be modified in multiple ways to make multiple security policies and associated predicates usable with schema 900 in FIG. 9, 1000 in FIGS. 10, and 1100 in FIG. 11. Thus, any number of modifications may be made to existing schemas within the scope of the invention depending on the nature and number of security policies being used.

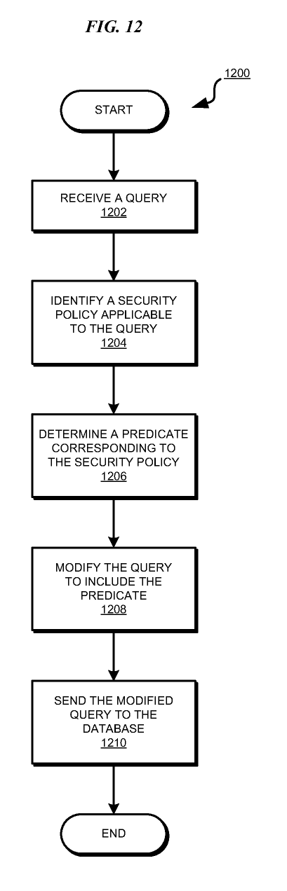

With reference to FIG. 12, this figure depicts a flowchart of a process of applying a security policy as a query predicate in accordance with an illustrative embodiment. Process 1200 may be implemented in a query modification application, such as query modification application 806 in FIG. 8.

Process 1200 begins by receiving a query (step 1202). Process 1200 identifies a security policy applicable to the query (step 1204).

Process 1200 determines a predicate that corresponds to the security policy identified in step 1204 (step 1206). Process 1200 modifies the query of step 1202 to include the predicate (step 1208). Process 1200 sends the modified query to the database (step 1210). Process 1200 ends thereafter.

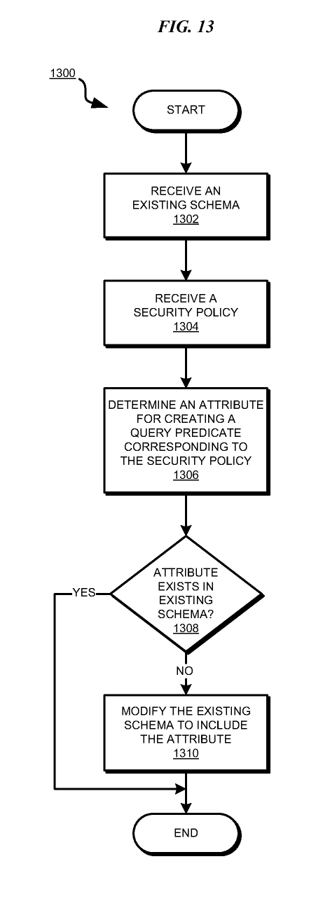

With reference to FIG. 13, this figure depicts a flowchart of a process of modifying a database schema to be usable with security policy predicates in accordance with an illustrative embodiment. Process 1300 may be implemented in a query modification application, such as query modification application 806 in FIG. 8. Process 1300 may also be implemented in any other database management application or a data repository application, such as middleware 708 in FIG. 7 or database front end 808 in FIG. 8.

Process 1300 begins by receiving an existing schema (step 1302). An embodiment may receive only a portion of an existing schema in step 1302 within the scope of the invention.

Process 1300 receives a security policy (step 1304). Process 1300 determines an attribute for creating a query predicate corresponding to the security policy (step 1306).

Process 1300 determines whether the attribute exists in the existing schema (step 1308). If the attribute exists (“Yes” path of step 1308), process 1300 ends thereafter, as no modification of the schema is needed. In one embodiment, the attribute may not exist but may be computable from other existing attributes for the determination of step 1308 to be “Yes”.

If the attribute does not exist, or is not computable from existing attributes (“No” path of step 1308), process 1300 modifies the existing schema to include the attribute (step 1310). Process 1300 ends thereafter. Process 1300 may modify the schema using any modification method, including but not limited to the schema modifications described in FIGS. 9, 10, and 11.

The components in the block diagrams and the steps in the flowcharts described above are described only as examples. The components and the steps have been selected for the clarity of the description and are not limiting on the illustrative embodiments of the invention. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the invention.

Any code or pseudo code described above is described only as an example. The nomenclature, identifiers, references, functions, operations, and data structures have been selected for the clarity of the description and are not limiting on the illustrative embodiments of the invention. Furthermore any logic, conditions, or processing have also been selected for the clarity of the description and are not limiting on the illustrative embodiments of the invention. Any notes or comments embedded in the code or pseudo code are not intended to be limiting on the invention and are included merely as additional clarifying information. The nomenclature, identifiers, references, functions, operations, data structures, logic, conditions, or processing can be combined, modified, or replaced, or alternatively implemented for similar purpose within the scope of the invention.

Thus, a computer implemented method, apparatus, and computer program product are provided in the illustrative embodiments for applying a security policy as a query predicate. Using the embodiments of the invention, a data processing system can operate with improved efficiency and data security when processing requests for data.

Using the embodiment, a data processing system may modify a data request to include a predicate corresponding to a security policy. The repository that provides the requested data can then process the request like any other request without knowing that a security policy has been applied to the request. The data resulting from the request is security policy compliant because of the inclusion of the security policy predicate in the data request.

The invention can take the form of an entirely software embodiment, or an embodiment containing both hardware and software elements. In a preferred embodiment, the invention is implemented in software or program code, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for applying a security policy as a query predicate, the computer implemented method comprising:
receiving a query, the query being a request for data, the query being directed to a data repository executing in a data processing system;
identifying the security policy, the security policy being a security policy applicable to the query;
determining a predicate corresponding to the security policy;
modifying the query to include the predicate; and
sending the modified query to the data repository.

2. The computer implemented method of claim 1, further comprising:
processing the modified query at the data repository without the data repository being awareness that the modified query is different from the query.

3. The computer implemented method of claim 1, wherein the modifying the query comprises:
combining the predicate with an existing predicate of the query such that the modified query performs an operation configured in the query but performs that operation within a constraint of the security policy.

4. The computer implemented method of claim 1, wherein determining the predicate is determining a set of predicates corresponding to one or more of the security policy, and wherein the modifying combines a subset of the set of predicates with the query.

5. The computer implemented method of claim 1, wherein the security policy is applicable to the query if the security policy describes a restriction on a data that participates in a processing of the query.

6. The computer implemented method of claim 1, wherein the identifying the security policy further comprises:
receiving the security policy from a source of security policy information, wherein the security policy is a set of security policies.

7. The computer implemented method of claim 1, wherein one of (i) the data repository is a relational database and the query is a relational SQL query, (ii) the data repository is an XML repository and the query is an XML query, and (iii) the data repository is a hybrid repository and the query is a relational SQL query.

8. A computer usable program product comprising a computer usable storage medium including computer usable code for applying a security policy as a query predicate, the computer usable code comprising:
computer usable code for receiving a query, the query being a request for data, the query being directed to a data repository executing in a data processing system;
computer usable code for identifying the security policy, the security policy being a security policy applicable to the query;
computer usable code for determining a predicate corresponding to the security policy;
computer usable code for modifying the query to include the predicate; and
computer usable code for sending the modified query to the data repository.

9. The computer usable program product of claim 8, further comprising:
computer usable code for processing the modified query at the data repository without the data repository being awareness that the modified query is different from the query.

10. The computer usable program product of claim 8, wherein the computer usable code for modifying the query comprises:
computer usable code for combining the predicate with an existing predicate of the query such that the modified query performs an operation configured in the query but performs that operation within a constraint of the security policy.

11. The computer usable program product of claim 8, wherein determining the predicate is determining a set of predicates corresponding to one or more of the security policy, and wherein the modifying combines a subset of the set of predicates with the query.

12. The computer usable program product of claim 8, wherein the security policy is applicable to the query if the security policy describes a restriction on a data that participates in a processing of the query.

13. The computer usable program product of claim 8, wherein the computer usable code for identifying the security policy further comprises:
computer usable code for receiving the security policy from a source of security policy information, wherein the security policy is a set of security policies.

14. The computer usable program product of claim 8, wherein one of (i) the data repository is a relational database and the query is a relational SQL query, (ii) the data repository is an XML repository and the query is an XML query, and (iii) the data repository is a hybrid repository and the query is a relational SQL query.

15. The computer usable program product of claim 8, wherein the computer usable code is stored in a computer readable storage medium in a data processing system, and wherein the computer usable code is transferred over a network from a remote data processing system.

16. The computer usable program product of claim 8, wherein the computer usable code is stored in a computer readable storage medium in a server data processing system, and wherein the computer usable code is downloaded over a network to a remote data processing system for use in a computer readable storage medium associated with the remote data processing system.

17. A data processing system for applying a security policy as a query predicate, the data processing system comprising:
a storage device including a storage medium, wherein the storage device stores computer usable program code; and
a processor, wherein the processor executes the computer usable program code, and wherein the computer usable program code comprises:
computer usable code for receiving a query, the query being a request for data, the query being directed to a data repository executing in a data processing system;
computer usable code for identifying the security policy, the security policy being a security policy applicable to the query;
computer usable code for determining a predicate corresponding to the security policy;
computer usable code for modifying the query to include the predicate; and
computer usable code for sending the modified query to the data repository.

18. The data processing system of claim 17, further comprising:
computer usable code for processing the modified query at the data repository without the data repository being awareness that the modified query is different from the query.

19. The data processing system of claim 17, wherein the computer usable code for modifying the query comprises:
computer usable code for combining the predicate with an existing predicate of the query such that the modified query performs an operation configured in the query but performs that operation within a constraint of the security policy.

20. The data processing system of claim 17, wherein determining the predicate is determining a set of predicates corresponding to one or more of the security policy, and wherein the modifying combines a subset of the set of predicates with the query.
